(19) United States
(12) Patent Application Publication
(10) Pub. No.: US 2025/0240751 A1
(43) Pub. Date: Jul. 24, 2025

(54) TIME SYNCHRONIZATION FOR SATELLITE BASED NETWORK

(71) Applicant: RAMON SPACE LTD., Yokneam Illit (IL)

(72) Inventors: Ofir Ben Ari Katzav, Zur AItshak (IL); Dan Peleg, Sde-Yizhak (IL)

(21) Appl. No.: 19/034,592

(22) Filed: Jan. 23, 2025

Related U.S. Application Data
(60) Provisional application No. 63/624,320, filed on Jan. 24, 2024.

(51) Int. Cl. H04W 56/00; H04L 5/00; H04L 27/26

(52) U.S. Cl. CPC H04W 56/005; H04L 5/0005; H04L 27/2607

(57) ABSTRACT

In one embodiment, a method includes computing time compensation values to compensate for propagation distance delays between at least one non-stationary satellite base station and end-user equipment, and causing at least part of a satellite-based wireless network to operate according to the computed time compensation values.

### RELATED APPLICATION INFORMATION

The present application claims benefit of U.S. Provisional Patent Application Ser. No. 63/624,320 of Ben Ari Katzav, et al., filed 24 Jan. 2024, the disclosure of which is hereby incorporated herein by reference.

### FIELD OF THE DISCLOSURE

The present disclosure relates to wireless networks, and in particular, but not exclusively to, wireless networks including satellite base stations.

### BACKGROUND

A constellation of non-geostationary, low-Earth orbit (LEO) satellites may form part of a wireless communication network. These satellites are in motion relative to the Earth, and they communicate with end-user equipment located either on the ground or onboard moving platforms, such as aircraft. Unlike terrestrial base stations, which are typically fixed and provide coverage over relatively small areas, the satellites in such a constellation orbit at altitudes ranging from approximately 500 to 2,000 kilometers above the Earth's surface. This orbital distance, while much higher than terrestrial base stations, is still relatively close to the Earth's surface compared to traditional geostationary satellites.

In a typical system of this kind, multiple satellites in the constellation work together to provide seamless communication coverage, employing advanced technologies like frequency reuse and beamforming to serve various users within their coverage areas. These satellites form a communication link between end-user equipment and the terrestrial network, delivering data, voice, and other services to users in other locations, or even in motion across regions. However, the relative movement of these satellites and the varying distances between them and the end-user equipment presents unique challenges that must be addressed to maintain efficient and interference-free communication.

### SUMMARY

There is provided in accordance with an embodiment of the present disclosure, a method, including computing time compensation values to compensate for propagation distance delays between at least one non-stationary satellite base station and end user equipment, and causing at least part of a satellite based wireless network to operate the computed time compensation values.

Further in accordance with an embodiment of the present disclosure, the method includes operating end user multiplexing in time and frequency domains by the at least one non-stationary base station based on the computed time compensation values.

Still further in accordance with an embodiment of the present disclosure, the method includes applying the computed time compensation values by the at least one non-stationary satellite base station to scheduled transmission times, and transmitting data, by the at least one non-stationary satellite base station to the end user equipment, the scheduled transmission times adjusted by the computed time compensation values.

Additionally in accordance with an embodiment of the present disclosure, the method includes selecting, by the at least one non-stationary satellite base station, quantities of cyclic prefixes for corresponding symbols to selectively schedule transmission of the symbols based on the scheduled transmission times adjusted by the computed time compensation values, and transmitting, by the at least one non-stationary satellite base station to the end user equipment, the symbols delays defined by the cyclic prefixes of the corresponding symbols.

Moreover, in accordance with an embodiment of the present disclosure, the method includes exchanging clock synchronization messages with a terrestrial clock leader, synchronizing at least one hardware clock of the at least one non-stationary satellite base station based on the exchanged clock synchronization messages, and transmitting the data based on at least one time of the at least one hardware clock.

Further in accordance with an embodiment of the present disclosure, the method includes computing transmission schedules for the end user equipment based on the computed time compensation values, and providing the transmission schedules to the end user equipment.

Still further in accordance with an embodiment of the present disclosure the computing includes computing the time compensation values to compensate for a difference in the propagation delays between the end user equipment and multiple non-stationary satellite base stations in order to synchronize the receipt of data at the end user equipment transmitted from the multiple non-stationary satellite base stations.

Additionally in accordance with an embodiment of the present disclosure the computing includes computing the time compensation values based on distances between the at least one non-stationary satellite base station and a coverage area in which the end user equipment is disposed.

Moreover, in accordance with an embodiment of the present disclosure the computing includes computing the time compensation values based on locations of the at least one non-stationary satellite base station and at least one location of the coverage area in which the end user equipment is disposed, the method further including finding the locations of the at least one non-stationary satellite base station based on any one or more of the following an Ephemeris schedule, data received from a global navigation satellite system (GNSS), or at least one previous location and velocity data of the at least one non-stationary satellite base station.

Further in accordance with an embodiment of the present disclosure the computing includes computing the time compensation values based on the locations of the at least one non-stationary satellite base station and at least one location of the end user equipment, and the method further including finding the at least one location of the end user equipment based on any one or more of the following triangulation with wireless base stations, global positioning system (GPS) data, or at least one previous location and velocity data of the end user equipment.

Still further in accordance with an embodiment of the present disclosure the computing includes computing the time compensation values based on an exchange of control messages in a process to grant access and allocate uplink resources to the end user equipment.

There is also provided in accordance with another embodiment of the present disclosure, a system, including at least one processor configured to compute time compensation values to compensate for propagation distance delays between at least one non-stationary satellite base station and end user equipment, and cause at least part of a satellite based wireless network to operate the computed time compensation values, and at least one memory to store data used by the at least one processor.

Additionally in accordance with an embodiment of the present disclosure, the system includes a satellite base station including the at least one processor and the at least one memory.

Moreover, in accordance with an embodiment of the present disclosure, the system includes the at least one non-stationary satellite base station which is configured to operate end user multiplexing in time and frequency domains based on the computed time compensation values.

Further in accordance with an embodiment of the present disclosure, the system includes the at least one non-stationary satellite base station, which is configured to apply the computed time compensation values to scheduled transmission times, and transmit data to the end user equipment the scheduled transmission times adjusted by the computed time compensation values.

Still further in accordance with an embodiment of the present disclosure the at least one non-stationary satellite base station is configured to select quantities of cyclic prefixes for corresponding symbols to selectively schedule transmission of the symbols based on the scheduled transmission times adjusted by the computed time compensation values, and transmit to the end user equipment the symbols delays defined by the cyclic prefixes of the corresponding symbols.

Additionally in accordance with an embodiment of the present disclosure the at least one non-stationary satellite base station includes at least one hardware clock, the at least one non-stationary satellite base station being configured to exchange clock synchronization messages with a terrestrial clock leader, synchronize the at least one hardware clock based on the exchanged clock synchronization messages, and transmit the data based on at least one time of the at least one hardware clock.

Moreover, in accordance with an embodiment of the present disclosure the at least one processor is configured to compute transmission schedules for the end user equipment based on the computed time compensation values, and provide the transmission schedules to the end user equipment.

Further in accordance with an embodiment of the present disclosure the at least one processor is configured to compute the time compensation values to compensate for a difference in the propagation delays between the end user equipment and multiple non-stationary satellite base stations in order to synchronize the receipt of data at the end user equipment transmitted from the multiple non-stationary satellite base stations.

Still further in accordance with an embodiment of the present disclosure the at least one processor is configured to compute the time compensation values based on distances between the at least one non-stationary satellite base station and a coverage area in which the end user equipment is disposed.

Additionally in accordance with an embodiment of the present disclosure the at least one processor is configured to compute the time compensation values based on locations of the at least one non-stationary satellite base station and at least one location of the coverage area in which the end user equipment is disposed, and find the locations of the at least one non-stationary satellite base station based on any one or more of the following an Ephemeris schedule, data received from a global navigation satellite system (GNSS), or at least one previous location and velocity data of the at least one non-stationary satellite base station.

Moreover, in accordance with an embodiment of the present disclosure the at least one processor is configured to compute the time compensation values based on the locations of the at least one non-stationary satellite base station and at least one location of the end user equipment, and find the at least one location of the end user equipment based on any one or more of the following triangulation with wireless base stations, global positioning system (GPS) data, or at least one previous location and velocity data of the end user equipment.

Further in accordance with an embodiment of the present disclosure the at least one processor is configured to compute the time compensation values based on an exchange of control messages in a process to grant access and allocate uplink resources to the end user equipment.

### BRIEF DESCRIPTION OF THE DRAWINGS

The present disclosure will be understood from the following detailed description, taken in conjunction with the drawings in which:

FIG. 1 is a partly pictorial, partly block diagram view of a satellite-based wireless network system constructed and operative in accordance with an embodiment of the present disclosure;

FIG. 2 is a flowchart including steps in a clock synchronization method for use in the system of FIG. 1;

FIG. 3 is a flowchart including steps in a method for use in the system of FIG. 1;

FIG. 4 is a flowchart including sub-steps of the method of FIG. 3; and

FIG. 5 is a partly pictorial, partly block diagram view of the satellite-based wireless network system of FIG. 1 transmitting data to end-user equipment.

### DESCRIPTION OF EXAMPLE EMBODIMENTS

### Overview

The primary challenge arises from the relatively large distances between the satellites in the constellation and the end-user equipment they serve. For example, the distance between a low-Earth orbiting satellite and end-user equipment on the ground is significantly greater than the typical distance between a terrestrial base station and a mobile device. This large distance introduces a time delay between signals transmitted by the satellite and those received by the mobile device.

Consider a situation where two satellites, each with antennas pointed toward the same area on the ground where a single end-user equipment is located, transmit or receive signals. If one satellite is closer to the end-user equipment, while the other is farther away, the difference in distance results in a timing discrepancy between the signals received by the end-user equipment from the satellites (or vice-versa). This timing difference is significant because it can disrupt the synchronization of the signals, causing errors and potential degradation of communication quality.

In a time-division duplex (TDD) system, where transmission and reception occur on the same frequency but at different times, this timing discrepancy becomes even more problematic. In such systems, users must be allocated specific time slots for transmitting and receiving signals, and precise timing is required to ensure proper communication and avoid interference. This issue is amplified when dealing with multiple end-user equipment, especially in situations where the satellite constellation covers a large geographic area with many users. In general, the term “end-user equipment”, as used in the specification and claims, may include one or more end-user equipment instances or end-user communication devices.

Furthermore, when a single satellite with a multi-beam antenna is used to serve multiple end-user equipment located in different regions, each end-user equipment must also be assigned distinct time slots for transmission and reception to prevent interference between end-user equipment communicating on the same frequency. The system must ensure that signals from one end-user equipment do not interfere with signals from another, which is especially challenging in scenarios with overlapping coverage areas.

The complexity of this problem is heightened by the dynamic nature of the system. Satellites are continuously moving in their orbits, which means the relative positions of the satellites and end-user equipment are constantly changing. The varying distances and orbital velocities introduce further challenges in maintaining synchronization, preventing interference, and efficiently allocating time slots for multiple users.

Therefore, there is a need for an improved system and method of managing time synchronization, and interference mitigation in wireless communication networks including one or more satellite base stations, particularly, but not exclusively for systems using TDD to support efficient communication for a large number of end users.

Embodiments of the present disclosure address at least some of the above drawbacks by providing a wireless communication network including satellite base stations in which communication is synchronized and time compensated for propagation distance delays caused by the distances between the satellite base stations and end-user equipment. Time compensation allows transmission conflicts, which could lead to interference and degradation in the wireless network between the end-user equipment and the satellite base stations, to be prevented or reduced. The system creates a synchronized network in the coverage region(s) of the end-user equipment near the Earth's surface by carefully synchronizing transmission by the satellite base stations and the end-user equipment based on the time compensation for the propagation distance delays.

In some embodiments, time compensation values are computed to compensate for propagation distance delays between one or more non-stationary satellite base stations and end-user equipment (i.e., one or more end-user communication devices) and cause at least part of the satellite-based wireless communication network to operate according to the computed time compensation values. In some embodiments, the satellite base station(s) may operate end-user multiplexing in time and frequency domains based on the computed time compensation values.

In some embodiments, the time compensation values are applied by the satellite base station(s) and/or the end-user equipment, and data is transmitted by the satellite base station(s) and/or the end-user equipment according to scheduled transmission times adjusted by the computed time compensation values.

In some embodiments, the time compensation values may be computed by one or more of the satellite base stations or by any suitable entity such as a terrestrial base station or any one or more devices. When the time compensation values are computed by each satellite for adjusting the transmission schedule of that satellite, that satellite may also instruct the relevant end-user equipment when to transmit data to that satellite or to any other suitable satellite(s). When the time compensation values are not computed by the satellite transmitting the relevant data, the device computing the time compensation values may send the time compensation values to the satellite(s) and/or to the relevant end-user equipment, or the device may instruct the satellite(s) and/or relevant end-user equipment when to transmit data and optionally when to expect data transmissions from different devices. In some embodiments, a network orchestrator may manage the scheduling of time slots for transmission between the different devices in the wireless communication network.

In some embodiments, the computation of the time compensation values may be based on the difference between propagation distance delays of two or more satellite base-stations to end-user equipment (e.g., in a coverage area covered by the relevant satellite base stations). In some embodiments, the computation of the time compensation values may aim to ensure that communication (transmission and/or receipt of data) is performed at the end-user equipment and/or at the satellite base station(s) during given time slots. For example, if the time compensation values are computed to compensate for the propagation delay difference between two satellites, one satellite, or both satellites may apply time compensation values when sending data.

In some embodiments, the time compensation values may be computed based on distances between the satellite(s) and the end-user equipment. As the distances between the satellite(s) and the end-user equipment changes over time, e.g., due to the orbit of the satellite(s), the time compensation values are recomputed intermittently.

The distance(s) between the satellite(s) and end-user equipment may be approximated based on a distance between the satellite(s) and the coverage area in which the end-user equipment is located. The distance(s) may be computed based on the location(s) of (the antenna(s) of) the satellite(s) and the location of the coverage area, such as the center of the coverage area or the center of the radio frequency beam(s) of the satellite(s), or the location of a terrestrial base-station in the coverage area, or the location(s) of the end-user equipment.

The location of a satellite base station may be found using any suitable method such as: based on a schedule of the satellite (e.g., Ephemeris); from a Global Navigation Satellite System (GNSS) receiver; or estimated based on a previous location and velocity (i.e., speed and direction of movement) of the satellite base station.

In some embodiments, to provide more granularity for the time compensation values, the location of the end-user equipment may be used when computing the time compensation values. The location of the end-user equipment may be found using any suitable method, such as: triangulation with terrestrial and/or satellite base stations; GPS location; or estimated based on a previous location and velocity of the end-user equipment. The latter method may be used for end-user equipment in a moving device such as a train, plane, or boat etc. that has a planned route and speed.

In some embodiments, the time compensation values may be computed based on an exchange of control messages (e.g., including a random-access response (RAR)) in a process (e.g., a random-access channel (RACH) procedure) to grant access and allocate uplink resources to the end-user equipment. The control messages may provide, or be used to compute, a measurement of the propagation delay from the end-user equipment to the satellite base station, which is exchanging the control messages with the end-user equipment. Future propagation delays may be estimated based on any suitable method including one or more of the previously mentioned methods.

The satellite base station(s) may adjust the timing of transmission of symbols based on the time compensation values by dynamically selecting a suitable quantity of cyclic prefixes to adjust the transmission times of corresponding symbols. For example, a first satellite may use 8 cyclic prefixes per symbol to cause a given delay in transmission to end-user equipment, whereas a second satellite which is further away from the end-user equipment, may use 6 cyclic prefixes per symbol to cause a shorter delay in transmission to the same end-user equipment to compensate for the higher propagation distance delay from the second satellite to the end-user equipment. As the first satellite and second satellite move with respect to the end-user equipment, the computed compensation values will change, and then the number of cyclic prefixes used by each satellite will also change.

The satellite base stations may include their own hardware clocks which maintain a wall-clock time, e.g., in Coordinated Universal Time (UTC). The hardware clocks may be clock synchronized to a clock leader or grand master using a clock synchronization protocol, such as PTP, in which clock synchronization messages are exchanged between the satellite base stations and the clock leader. The terrestrial base stations, and the end-user equipment may also be clock synchronized to the clock leader. The time maintained by the hardware clock of a given satellite base station may then be used to schedule data transmissions to further enhance the time synchronization in the wireless communication network.

### System Description

Documents incorporated by reference herein are to be considered an integral part of the application except that, to the extent that any terms are defined in these incorporated documents in a manner that conflicts with definitions made explicitly or implicitly in the present specification, only the definitions in the present specification should be considered.

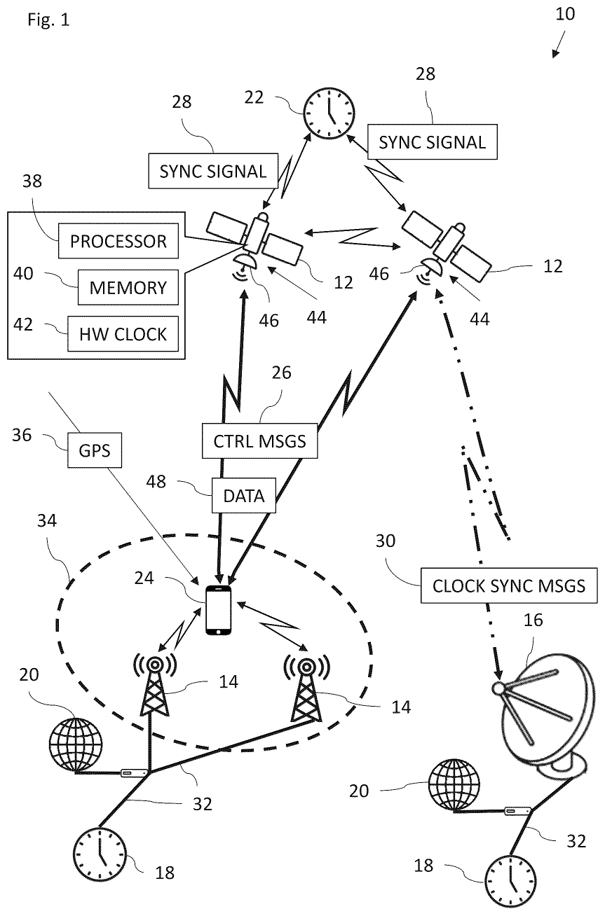

Reference is now made to FIG. 1, which is a partly pictorial, partly block diagram view of a satellite-based wireless network system 10 constructed and operative in accordance with an embodiment of the present disclosure.

In some embodiments, the system 10 includes a constellation of non-stationary satellite base stations 12 moving in orbit around the Earth, terrestrial base stations 14, one or more satellite constellation gateways 16, one or more terrestrial-based time synchronization sources 18, terrestrial core network and Internet access points 20, a GNSS time synchronization source 22, and end-user equipment 24 (only one shown for the sake of simplicity). In some embodiments, satellite-based wireless network system 10 includes non-stationary satellite base stations 12 without terrestrial base stations 14. The system 10 may be any suitable wireless network system including non-stationary satellite base stations 12. In some embodiments, system 10 is a cellular network including non-stationary satellite base stations 12.

The non-stationary satellite base stations 12 are configured to communicate wirelessly with the end-user equipment 24 including exchanging data 48 and control messages 26, described in more detail below. The communication distances are typically greater than hundreds of kilometers. The non-stationary satellite base stations 12 may be configured to wirelessly receive a synchronization signal 28 from GNSS time synchronization source 22 in order to time synchronize to the GNSS time synchronization source 22, for example. The non-stationary satellite base stations 12 are configured to communicate wirelessly with the satellite constellation gateway 16 including exchanging data, control messages, and optionally clock synchronization messages 30, described in more detail below. The non-stationary satellite base stations 12 may be configured to exchange data directly with each other for example, timing signals to synchronize non-stationary satellite base stations 12 that are not in the coverage area of the satellite constellation gateway 16.

The satellite constellation gateway(s) 16 and terrestrial base stations 14 are connected via wired links 32 to terrestrial-based time synchronization sources 18 (e.g., GNSS or PTP leader or grand master) and terrestrial core network and Internet access points 20. The terrestrial base stations 14, satellite constellation gateway 16, and end-user equipment 24 may be configured to time synchronize with terrestrial-based time synchronization sources 18.

The end-user equipment 24 is configured to communicate wirelessly with the non-stationary satellite base stations 12 and the terrestrial base stations 14 in the reception area of the end-user equipment 24. The communication distances between the end-user equipment 24 and terrestrial base stations 14 are typically in the order of tens of kilometers. The end-user equipment 24 is also configured for long-distance wireless communication (e.g., in any suitable range of hundreds of kilometers, such as between 500 and 2000 kilometers) directly with the satellite base stations 12 and does not need to communicate via any of device in order to communicate with non-stationary satellite base stations 12.

The end-user equipment 24 shown in the example of FIG. 1 is in a coverage area 34 of one or more radio frequency (RF) beams transmitted by the non-stationary satellite base stations 12. FIG. 1 shows two non-stationary satellite base stations 12 and two terrestrial base stations 14 by way of example. The system 10 may include any suitable number of non-stationary satellite base stations 12 and any suitable number of terrestrial base stations 14. The example of FIG. 1 shows the end-user equipment 24 communicating with two non-stationary satellite base stations 12 and terrestrial base stations 14. In some cases, the end-user equipment 24 may communicate with one terrestrial base station 14 and one non-stationary satellite base station 12, or more than one (e.g., two or more) terrestrial base station 14 and one non-stationary satellite base station 12, or one terrestrial base station 14 and more than one (e.g., two or more) non-stationary satellite base stations 12. The end-user equipment 24 may be configured to receive GPS data 36 to determine a location of end-user equipment 24, described in more detail below.

Each non-stationary satellite base station 12 may include one or more processor(s) 38, at least one memory 40 and optionally a hardware clock 42. The memory/memories 40 is/are configured to store data used by processor(s) 38. The non-stationary satellite base stations 12 may also include communication equipment 44, which may include one or more antennas 46. Similarly other devices in system 10 may include one or more processors, memory, and optionally a hardware clock. The functionality described below as being performed by the processor(s) 38 may be performed by the processor(s) 38 of each non-stationary satellite base stations 12, or distributed among the processors 38 of the non-stationary satellite base stations 12, or wholly (or at least partially) performed by another processor or processors of one or more other devices (e.g., satellite constellation gateway 16, terrestrial base stations 14, or other devices).

The processor(s) 38 is configured to compute time compensation values to compensate for propagation distance delays between non-stationary satellite base station(s) 12 and end-user equipment 24 and cause at least part of the satellite-based wireless network to operate according to the computed time compensation values, as described in more detail below. In some embodiments, the non-stationary satellite base stations 12 are configured to operate end-user multiplexing in time and frequency domains based on the computed time compensation values.

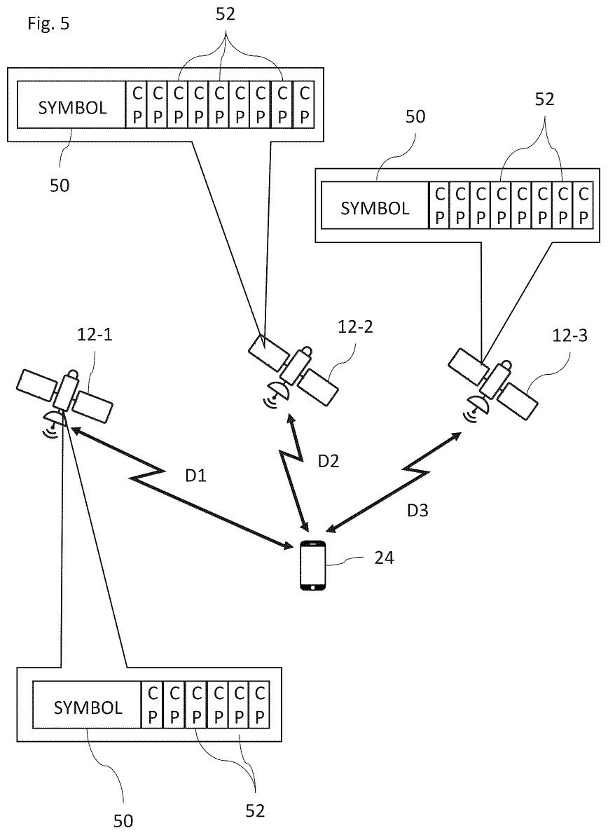

The non-stationary satellite base station(s) 12 is configured to apply the computed time compensation values to scheduled transmission times and transmit data, which may include any suitable data such as information, voice and video data, to the end-user equipment 24 according to the scheduled transmission times adjusted by the computed time compensation values. In some embodiments, selectively adjusting the quantity of cyclic prefixes before symbols (i.e., data) may be used to adjust the transmission time of the symbols, as described in more detail with reference to FIG. 5. In overview, the non-stationary satellite base stations 12 are configured to select quantities of cyclic prefixes for corresponding symbols to selectively schedule transmission of the symbols based on the scheduled transmission times adjusted by the computed time compensation values, and transmit to the end-user equipment 24 the symbols according to delays defined by the cyclic prefixes of the corresponding symbols.

In some embodiments, the non-stationary satellite base station(s) 12 is configured to exchange clock synchronization messages 30 (e.g., PTP messages) with a terrestrial clock leader such as one of terrestrial-based time synchronization sources 18, and synchronize the hardware clock(s) 42 based on the exchanged clock synchronization messages 30. The non-stationary satellite base station(s) 12 may then transmit data based on time(s) of the hardware clock(s) 42, for example, according to the scheduled transmission times adjusted by the computed time compensation values.

In some embodiments, the processor(s) 38 is configured to compute transmission schedules for the end-user equipment 24 based on the computed time compensation values, and provide the transmission schedules to the end-user equipment 24. In some embodiments, the processor(s) 38 is configured to compute the time compensation values to compensate for a difference in the propagation delays between the end-user equipment 24 and multiple non-stationary satellite base stations 12 in order to synchronize the receipt of data at the end-user equipment 24 transmitted from the multiple non-stationary satellite base stations 12.

In some embodiments, the computation of the time compensation values may aim to ensure that communication (transmission and/or receipt of data) is performed at the end-user equipment 24 and/or at the non-stationary satellite base station(s) 12 during given time slots. For example, if the time compensation values are computed to compensate for the propagation delay difference between two non-stationary satellite base stations 12, one satellite, or both satellites may apply time compensation values when sending data.

For example, if the propagation distance delay between satellite A and end-user equipment 24 is equal to X and the propagation distance delay between satellite B and end-user equipment 24 is equal to Y (which is greater than X), the difference between the propagation distance delays is equal to Z, which is equal to Y minus X. In some cases, satellite A may adjust (e.g., advance) its scheduled transmissions by X and satellite B by Y. In some cases, satellite A or satellite B may adjust its scheduled transmissions by Z to ensure that data sent by both satellite A and B arrives at end-user equipment 24 at around the same time. In some cases, the difference in delay Z may be compensated by both satellite A and satellite B, so that satellite A sends data delayed by a given amount from the scheduled times and satellite B sends data in advance of the scheduled times by a given amount.

In some embodiments, the processor(s) 38 is configured to compute the time compensation values based on distances between the non-stationary satellite base station(s) 12 and coverage area 34 in which the end-user equipment 24 is disposed. The distances between non-stationary satellite base station(s) 12 and end-user equipment 24 are constantly changing due to the movement of non-stationary satellite base stations 12 and optionally the movement of end-user equipment 24. In some embodiments, the time compensation values may be computed based on locations of non-stationary satellite base stations 12 over time and the location(s) of the coverage area 34 in which the end-user equipment 24 is disposed.

The location of the coverage area 34 may be approximated as the center of the coverage area 34 defined by the center of the RF beam(s) transmitted by the non-stationary satellite base station(s) 12. The locations of the non-stationary satellite base stations 12 may be found using any suitable method, for example, based on any one or more of the following: an Ephemeris schedule; data received from a global navigation satellite system (GNSS) (e.g., GNSS time synchronization source 22); or previous location(s) and velocity data of the non-stationary satellite base station(s) 12.

In order to provide finer granularity, the processor(s) 38 may be configured to compute the time compensation values based on the locations of non-stationary satellite base stations 12 and location(s) of the end-user equipment 24. The location(s) of end-user equipment 24 may be founds using any suitable method, for example, based on any one or more of the following: triangulation with wireless base-stations (e.g., terrestrial base station(s) 14 and/or non-stationary satellite base station(s) 12); global positioning system (GPS) data 36; or previous location(s) and velocity data of the end-user equipment 24. For example, if end-user equipment 24 is installed on a train, airplane, or boat, scheduling data may be used to compute the location of end-user equipment 24.

In some embodiments, the time compensation values may be computed directly from the propagation distance delays from the non-stationary satellite base station(s) 12 to the end-user equipment 24 using any suitable method, for example, from the round-trip time from the non-stationary satellite base station(s) 12 to the end-user equipment 24 and back again. In some embodiments, the processor(s) 38 is configured to compute the time compensation values based on an exchange of control messages 26 (e.g., RAR) in a process (e.g., RACH procedure) to grant access and allocate uplink resources to the end-user equipment 24.

In some embodiments, the time compensation values may be computed by one or more of the non-stationary satellite base stations 12 or by any suitable entity such as the satellite constellation gateway(s) 16, the terrestrial base station(s) 14 or any one or more devices. When the time compensation values are computed by each non-stationary satellite base station 12 for adjusting the transmission schedule of that non-stationary satellite base station 12, that non-stationary satellite base station 12 may also instruct the relevant end-user equipment 24 when to transmit data to that non-stationary satellite base station 12 or to any other suitable non-stationary satellite base station(s) 12. When the time compensation values are not computed by the non-stationary satellite base station(s) 12 transmitting the relevant data, the device computing the time compensation values sends the time compensation values to the non-stationary satellite base station(s) 12 and/or to the relevant end-user equipment, or instructs the non-stationary satellite base station(s) 12 and/or relevant end-user equipment 24 when to transmit data and optionally when to expect data transmissions from different devices or entities. In some embodiments, a network orchestrator (not shown) may manage the scheduling of time slots for transmission between the different devices in the wireless communication network.

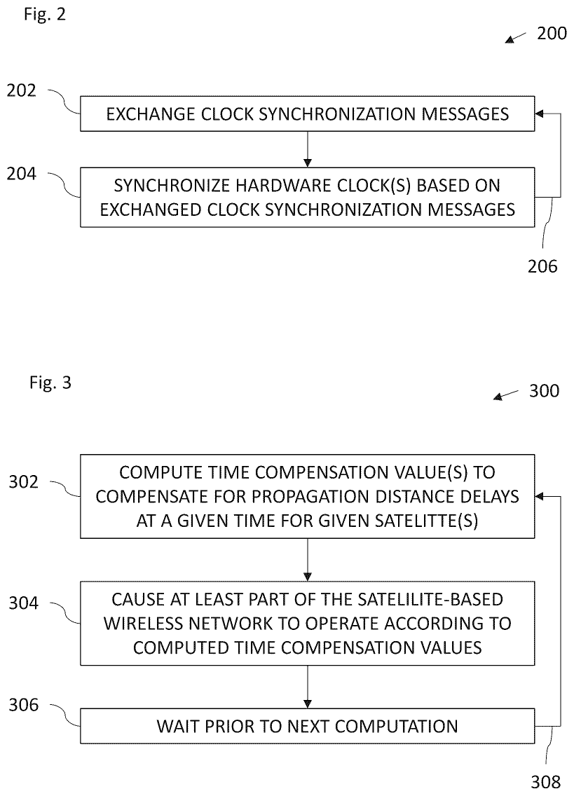

Reference is now made to FIG. 2, which is a flowchart 200 including steps in a clock synchronization method for use in the system 10 of FIG. 1. The non-stationary satellite base stations 12 may include their own hardware clocks 42 which maintain a wall-clock time (e.g., in Coordinated Universal Time (UTC)). The hardware clocks 42 may be clock synchronized to a clock leader or grand master using a clock synchronization protocol (such as PTP), such as one of terrestrial-based time synchronization sources 18 (via satellite constellation gateway 16 for example). In some embodiments, the processor(s) 38 of non-stationary satellite base station(s) 12 are configured to exchange clock synchronization messages 30 (e.g., PTP messages) with a terrestrial clock leader such as one of terrestrial-based time synchronization sources 18 (block 202), and synchronize the hardware clock(s) 42 based on the exchanged clock synchronization messages 30 (block 204). The non-stationary satellite base station(s) 12 may then transmit data based on time(s) of the hardware clock(s) 42, for example, according to the scheduled transmission times adjusted by the computed time compensation values. The terrestrial base stations 14, and the end-user equipment 24 may also be clock synchronized to the clock leader. The steps of blocks 202 and 204 are repeated intermittently (e.g., periodically) (arrow 206).

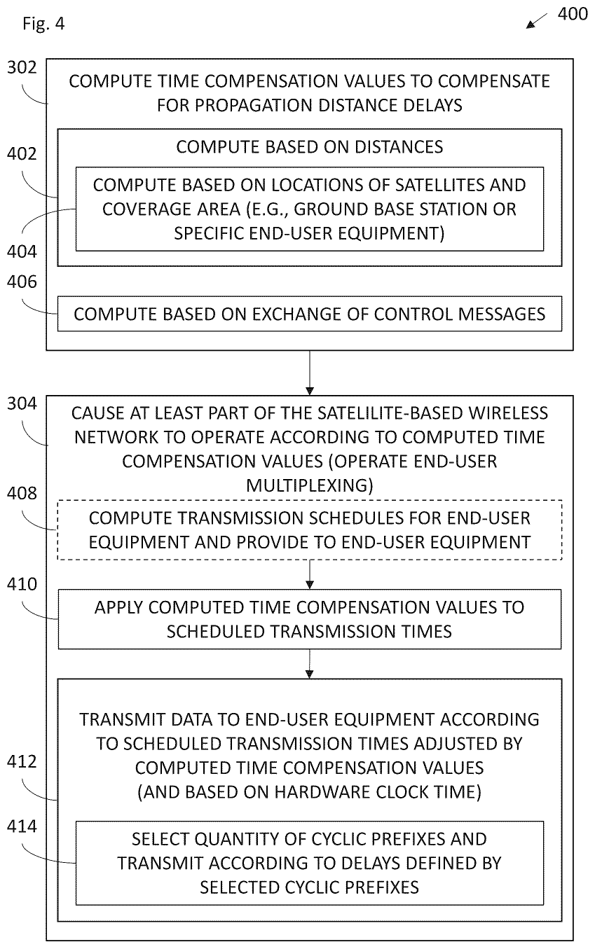

Reference is now made to FIG. 3, which is a flowchart 300 including steps in a method for use in the system 10 of FIG. 1. The processor(s) 38 is configured to compute time compensation values to compensate for propagation distance delays between non-stationary satellite base station(s) 12 and end-user equipment 24 (block 302) and cause at least part of the satellite-based wireless network to operate according to the computed time compensation values (block 304), as described in more detail below with reference to FIG. 4. The processor(s) 38 may be configured to wait prior to the next computation (block 306) and then repeat (arrow 308) the steps of block 302 and 304. The term “computing” or “compute”, as used in the specification and claims, includes estimating, such as estimating the time compensation values based on estimated values such as propagation distance delays, distances, locations, and round-trip times. The term “end-user equipment” as used in the specification and claims may refer to one or more end-user equipment instances or end-user communication devices.

Reference is now made to FIG. 4, which is a flowchart 400 including sub-steps of the method of FIG. 3. The flowchart 400 describes the steps of blocks 302 and 304 of FIG. 3 in more detail.

The processor(s) 38 is configured to compute the time compensation values to compensate for propagation distance delays between the non-stationary satellite base station(s) 12 and end-user equipment 24 (block 302). In some embodiments, the processor(s) 38 is configured to compute the time compensation values to compensate for a difference in the propagation delays between the end-user equipment 24 and multiple non-stationary satellite base stations 12 in order to synchronize the receipt of data at the end-user equipment 24 transmitted from the multiple non-stationary satellite base stations 12.

In some embodiments, the processor(s) 38 is configured to compute the time compensation values based on distances between the non-stationary satellite base station(s) 12 and coverage area 34 in which the end-user equipment 24 is disposed (block 402). As the non-stationary satellite base station(s) 12 and optionally the end-user equipment 24 move, the time compensation values are recomputed intermittently based on the new distances between the non-stationary satellite base station(s) 12 and the end-user equipment 24.

In some embodiments, the processor(s) 38 is configured to compute the time compensation values based on locations of the non-stationary satellite base station(s) 12 (over time) and location(s) of the coverage area 34 in which the end-user equipment 24 is disposed (block 404). In some embodiments, the processor(s) 38 is configured to find the locations of the non-stationary satellite base station(s) 12 based on any one or more of the following: an Ephemeris schedule; data received from a global navigation satellite system (GNSS) (e.g., GNSS time synchronization source 22); previous location(s) and velocity data of the non-stationary satellite base station(s) 12; or any suitable method.

In some embodiments, the location(s) of the coverage area 34 are defined by the individual location(s) of the end-user equipment 24. Therefore, the processor(s) 38 may be configured to compute the time compensation values based on the locations of the non-stationary satellite base station(s) 12 and the location(s) of the end-user equipment 24. The processor(s) 38 may be configured to find the location(s) of the end-user equipment 24 based on any one or more of the following: triangulation with wireless base-stations such as non-stationary satellite base station(s) 12 and/or terrestrial base station(s) 14; global positioning system (GPS) data 36; previous location(s) and velocity data of the end-user equipment; or any suitable method.

In some embodiments the time compensation values may be computed based on the propagation delay between the non-stationary satellite base station(s) 12 and end-user equipment 24 without using the distance between the non-stationary satellite base stations 12 and the coverage area 34. In some embodiments, the processor(s) 38 is configured to compute the time compensation values based on an exchange of control messages 26 (e.g., RAR) in a process (e.g., RACH) to grant access and allocate uplink resources to the end-user equipment (block 406).

The processor(s) 38 is configured to cause at least part of the satellite-based wireless network system 10 to operate according to the computed time compensation values (block 304) optionally including operating end-user multiplexing in time and frequency domains based on the computed time compensation values. In some embodiments, the processor(s) 38 is configured to compute transmission schedules for the end-user equipment 24 based on the computed time compensation values and provide the transmission schedules to the end-user equipment 24 (block 408).

In some embodiments, the processor(s) 38 is configured to apply the computed time compensation values station to scheduled transmission times (block 410), e.g., by updating the scheduled transmission times, and communication equipment 44 of the non-stationary satellite base station(s) 12 is configured to transmit data to the end-user equipment 24, according to the scheduled transmission times adjusted by the computed time compensation values (block 412).

Reference is now made to FIG. 5, which is a partly pictorial, partly block diagram view of the satellite-based wireless network system 10 of FIG. 1 transmitting data to end-user equipment 24. FIG. 5 may illustrate two scenarios. One scenario is three non-stationary satellite base stations 12, namely non-stationary satellite base stations 12-1, 12-2, 12-3, transmitting data to end-user equipment 24 while the different non-stationary satellite base stations 12 have different distances to end-user equipment 24. The distances between non-stationary satellite base stations 12-1, 12-2, 12-3 and end-user equipment 24 are equal to D1, D2 and D3, respectively. D1 is greater than D3, which is greater than D2.

Another scenario is that a single non-stationary satellite base station 12 is shown in FIG. 3 at three positions with respect to end-user equipment 24 at different times of the day due to the orbit of non-stationary satellite base station 12 around the Earth, and the non-stationary satellite base stations 12-1, 12-2, 12-3 show three positions of that single non-stationary satellite base station 12. The position of non-stationary satellite base station 12-2 may be facing nadir on Earth, whereas the positions of non-stationary satellite base stations 12-1, 12-3 may be after sunrise and before sunset, respectively.

For the sake of simplicity, the description below assumes that the non-stationary satellite base stations 12-1, 12-2, 12-3 are three different non-stationary satellite base stations 12. However, the description may also be applied to the scenario in which non-stationary satellite base stations 12-1, 12-2, 12-3 are the same non-stationary satellite base station 12 at different relative positions with respect to end-user equipment 24 at different times of the day.

The non-stationary satellite base stations 12 may adjust the timing of transmission of symbols 50 based on the time compensation values by dynamically selecting a suitable quantity of cyclic prefixes 52 (only some labeled for the sake of simplicity) to adjust the transmission times of corresponding symbols 50. In the example of FIG. 5, non-stationary satellite base station 12-1 uses 6 cyclic prefixes per symbol 50, non-stationary satellite base station 12-2 uses 9 cyclic prefixes per symbol 50, and non-stationary satellite base station 12-3 uses 8 cyclic prefixes per symbol 50. In this manner, symbols transmitted by non-stationary satellite base stations 12-1, 12-2, 12-3 based on delays of 6, 9 and 8 cyclic prefixes, respectively, will arrive at end-user equipment 24 at substantially the same time. As the non-stationary satellite base stations 12-1, 12-2, 12-3 move with respect to the end-user equipment 24, the computed compensation values will change, and then the number of cyclic prefixes 52 used by each satellite will also change.

Therefore, the processor(s) 38 of each non-stationary satellite base station 12 is configured to select quantities of cyclic prefixes 52 for corresponding symbols 50 to selectively schedule transmission of the symbols 50 based on the scheduled transmission times adjusted by the computed time compensation values. The communication equipment 44 of each non-stationary satellite base station 12 is configured to transmit to the end-user equipment 24, the symbols 50 according to delays defined by the cyclic prefixes 52 of the corresponding symbols (block 414).

In practice, some or all of the functions of processor(s) 38 may be combined in a single physical component or, alternatively, implemented using multiple physical components. These physical components may comprise hard-wired or programmable devices, or a combination of the two. In some embodiments, at least some of the functions of the processor(s) 38 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

The flowchart and block diagrams in the figures illustrate the architecture, functionality, and operation of possible implementations of systems, methods and computer program products according to various examples of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. The descriptions of the various examples of the present disclosure have been presented for purposes of illustration, but are not intended to be exhaustive or limited to the examples disclosed. Many modifications and variations will be apparent to those of ordinary skill in the art without departing from the scope and spirit of the described examples.

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

What is claimed is:

1. A method, comprising:
computing time compensation values to compensate for propagation distance delays between at least one non-stationary satellite base station and end-user equipment; and
causing at least part of a satellite-based wireless network to operate according to the computed time compensation values.

2. The method according to claim 1, further comprising operating end-user multiplexing in time and frequency domains by the at least one non-stationary base station based on the computed time compensation values.

3. The method according to claim 1, further comprising:
applying the computed time compensation values by the at least one non-stationary satellite base station to scheduled transmission times; and
transmitting data, by the at least one non-stationary satellite base station to the end-user equipment, according to the scheduled transmission times adjusted by the computed time compensation values.

4. The method according to claim 3, further comprising:
selecting, by the at least one non-stationary satellite base station, quantities of cyclic prefixes for corresponding symbols to selectively schedule transmission of the symbols based on the scheduled transmission times adjusted by the computed time compensation values; and
transmitting, by the at least one non-stationary satellite base station to the end-user equipment, the symbols according to delays defined by the cyclic prefixes of the corresponding symbols.

5. The method according to claim 3, further comprising:
exchanging clock synchronization messages with a terrestrial clock leader;
synchronizing at least one hardware clock of the at least one non-stationary satellite base station based on the exchanged clock synchronization messages; and
transmitting the data based on at least one time of the at least one hardware clock.

6. The method according to claim 1, further comprising:
computing transmission schedules for the end-user equipment based on the computed time compensation values; and
providing the transmission schedules to the end-user equipment.

7. The method according to claim 1, wherein the computing includes computing the time compensation values to compensate for a difference in the propagation delays between the end-user equipment and multiple non-stationary satellite base stations in order to synchronize the receipt of data at the end-user equipment transmitted from the multiple non-stationary satellite base stations.

8. The method according to claim 1, wherein the computing includes computing the time compensation values based on distances between the at least one non-stationary satellite base station and a coverage area in which the end-user equipment is disposed.

9. The method according to claim 8, wherein the computing includes computing the time compensation values based on locations of the at least one non-stationary satellite base station and at least one location of the coverage area in which the end-user equipment is disposed, the method further comprising finding the locations of the at least one non-stationary satellite base station based on any one or more of the following: an Ephemeris schedule; data received from a global navigation satellite system (GNSS); or at least one previous location and velocity data of the at least one non-stationary satellite base station.

10. The method according to claim 9, wherein the computing includes computing the time compensation values based on the locations of the at least one non-stationary satellite base station and at least one location of the end-user equipment, and the method further comprising finding the at least one location of the end-user equipment based on any one or more of the following: triangulation with wireless base-stations; global positioning system (GPS) data; or at least one previous location and velocity data of the end-user equipment.

11. The method according to claim 1, wherein the computing includes computing the time compensation values based on an exchange of control messages in a process to grant access and allocate uplink resources to the end-user equipment.

12. A system, comprising:
at least one processor configured to:
compute time compensation values to compensate for propagation distance delays between at least one non-stationary satellite base station and end-user equipment; and
cause at least part of a satellite-based wireless network to operate according to the computed time compensation values; and
at least one memory to store data used by the at least one processor.

13. The system according to claim 12, further comprising a satellite base station including the at least one processor and the at least one memory.

14. The system according to claim 12, further comprising the at least one non-stationary satellite base station which is configured to operate end-user multiplexing in time and frequency domains based on the computed time compensation values.

15. The system according to claim 12, further comprising the at least one non-stationary satellite base station, which is configured to:
apply the computed time compensation values to scheduled transmission times; and
transmit data to the end-user equipment according to the scheduled transmission times adjusted by the computed time compensation values.

16. The system according to claim 15, wherein the at least one non-stationary satellite base station is configured to:
select quantities of cyclic prefixes for corresponding symbols to selectively schedule transmission of the symbols based on the scheduled transmission times adjusted by the computed time compensation values; and
transmit to the end-user equipment the symbols according to delays defined by the cyclic prefixes of the corresponding symbols.

17. The system according to claim 15, wherein the at least one non-stationary satellite base station includes at least one hardware clock, the at least one non-stationary satellite base station being configured to:
exchange clock synchronization messages with a terrestrial clock leader;
synchronize the at least one hardware clock based on the exchanged clock synchronization messages; and
transmit the data based on at least one time of the at least one hardware clock.

18. The system according to claim 12, wherein the at least one processor is configured to:
compute transmission schedules for the end-user equipment based on the computed time compensation values; and
provide the transmission schedules to the end-user equipment.

19. The system according to claim 12, wherein the at least one processor is configured to compute the time compensation values to compensate for a difference in the propagation delays between the end-user equipment and multiple non-stationary satellite base stations in order to synchronize the receipt of data at the end-user equipment transmitted from the multiple non-stationary satellite base stations.

20. The system according to claim 12, wherein the at least one processor is configured to compute the time compensation values based on distances between the at least one non-stationary satellite base station and a coverage area in which the end-user equipment is disposed.

21. The system according to claim 20, wherein the at least one processor is configured to:
compute the time compensation values based on locations of the at least one non-stationary satellite base station and at least one location of the coverage area in which the end-user equipment is disposed; and
find the locations of the at least one non-stationary satellite base station based on any one or more of the following: an Ephemeris schedule; data received from a global navigation satellite system (GNSS); or at least one previous location and velocity data of the at least one non-stationary satellite base station.

22. The system according to claim 21, wherein the at least one processor is configured to:
compute the time compensation values based on the locations of the at least one non-stationary satellite base station and at least one location of the end-user equipment; and
find the at least one location of the end-user equipment based on any one or more of the following: triangulation with wireless base-stations; global positioning system (GPS) data; or at least one previous location and velocity data of the end-user equipment.

23. The system according to claim 12, wherein the at least one processor is configured to compute the time compensation values based on an exchange of control messages in a process to grant access and allocate uplink resources to the end-user equipment.
